(19) United States
(12) Patent Application Publication
(10) Pub. No.: US 2026/0178035 A1
(43) Pub. Date: Jun. 25, 2026

(54) AUTOMATIC CLEANING DEVICE AND CLEANING SYSTEM

(71) Applicant: Beijing Roborock Technology Co., Ltd., Beijing (CN)

(72) Inventors: Dan Liu, Beijing (CN); Ke Pan, Beijing (CN)

(21) Appl. No.: 19/544,968

(22) Filed: Feb. 19, 2026

Related U.S. Application Data
(63) Continuation of application No. PCT/CN2024/113125, filed on Aug. 19, 2024.

(30) Foreign Application Priority Data
Aug. 25, 2023 (CN) 202322318458.9

(51) Int. Cl. G05D 1/242; A47L 11/40; G05D 1/622; G05D 105/10

(52) U.S. Cl. CPC G05D 1/242; A47L 11/4002; A47L 11/4011; A47L 11/4061; G05D 1/622; A47L 2201/04; G05D 2105/10

(57) ABSTRACT

An automatic cleaning device, a cleaning system, and a method for controlling an automatic cleaning device. The automatic cleaning device includes: an automatic cleaning device body; and a sensing assembly, the sensing assembly being disposed on the automatic cleaning device body, and including a line laser emitter and an RGB image sensor, wherein the line laser emitter is configured for emitting a line laser, the emission direction of the line laser being horizontally and downward inclined, and the line laser emitter includes an emission assembly configured for emitting a single-line laser beam.

### CROSS REFERENCE TO RELATED APPLICATIONS

The present disclosure is a continuation application of International Application No. PCT/CN2024/113125, filed on Aug. 19, 2024, which is based upon and claims priority to Chinese Patent Application No. 202322318458.9, filed on Aug. 25, 2023, the entire contents of which are incorporated herein by reference.

### TECHNICAL FIELD

Embodiments of the present application relate to the field of automatic cleaning devices, and in particular to an automatic cleaning device and a cleaning system.

### BACKGROUND

With the development of technologies, service robots such as cleaning robots, food delivery robots and commercial robots have been increasingly involved in every aspect of life. For all types of robots, the functional requirement for active obstacle avoidance is involved. The functions above require robots capable of accurately avoiding obstacles such as shoes, chairs, and scales in complex environments.

### SUMMARY

In a first aspect of the present disclosure, an automatic cleaning device is provided.

In a second aspect of the present disclosure, a cleaning system is provided.

In view of this, according to the first aspect of an embodiment of the present application, an automatic cleaning device is provided. The automatic cleaning device includes:
an automatic cleaning device body; and
a sensing assembly disposed on the automatic cleaning device body, where the sensing assembly includes a line laser emitter and an RGB image sensor, and the line laser emitter is configured for emitting a line laser in an emission direction that is horizontally and downward inclined, wherein the line laser emitter includes an emission assembly configured for emitting a single-line laser beam.

In a possible embodiment, the RGB image sensor is configured for acquiring environmental image information of the automatic cleaning device body as first image information.

In a possible embodiment, the automatic cleaning device further includes:
a processor connected to the line laser emitter and the RGB image sensor, and configured for executing an obstacle avoidance strategy based on information obtained from the line laser emitter and the RGB image sensor.

In a possible embodiment, the line laser emitter further includes:
a receiving assembly configured for acquiring second image information of the laser on an object.

In a possible embodiment, the emission assembly includes:
a drive circuit; and
a VCSEL unit, where the drive circuit is connected to the VCSEL unit, the VCSEL unit is configured for emitting the laser, and the drive circuit is configured for driving the VCSEL unit to emit the laser.

In a possible embodiment, the emission assembly further includes:
a focusing lens assembly configured for focusing the laser emitted via the VCSEL unit; and
a wave lens assembly disposed on a side of the focusing lens assembly away from the VCSEL unit, wherein the wave lens assembly is configured for projecting a focused laser in a linear shape.

In a possible embodiment, the receiving assembly includes:
a sensor;
a lens assembly configured for imaging, on the sensor, a line laser reflected by the object;
a filter assembly disposed on a side of the lens assembly away from the sensor; and
a signal processor connected to the sensor and configured for converting a photoelectric signal into a digital signal.

In a possible embodiment, the sensing assembly further includes:
a housing connected to the automatic cleaning device body; and
a bracket configured for connection to the housing,
where at least one of the line laser emitter or the RGB image sensor is connected to the bracket.

In a possible embodiment, the sensing assembly further includes:
a fill-in light connected to the bracket and configured for filling light for the RGB image sensor.

In a possible embodiment, the automatic cleaning device further includes:
a protective lens configured for covering at least one of the RGB image sensor, the fill-in light, or the line laser emitter.

In a possible embodiment, a hollow-out portion is formed in a region of the protective lens corresponding to the fill-in light.

In a possible embodiment, a mounting hole is formed in the housing, and at least one of the line laser emitter or the RGB image sensor either sends or receives a signal via the mounting hole.

In a possible embodiment, the sensing assembly further includes:
a pile-finding light receiver configured for receiving a pile-finding signal emitted by a base station.

In a possible embodiment, the pile-finding light receiver is disposed on the bracket.

In a possible embodiment, an output direction of the emission assembly is inclined at an angle ranging from 7.5° to 15° in a ground-hitting direction.

According to the second aspect of an embodiment of the present application, a cleaning system is provided. The cleaning system includes:
the automatic cleaning device in any one of the technical solutions as described above; and
a cleaning base station configured for providing maintenance to the automatic cleaning device.

According to the third aspect of an embodiment of the present application, a method for controlling an automatic cleaning device is provided. The method includes:
controlling an emission assembly of the automatic cleaning device to emit a single-line laser beam inclining in a ground-hitting direction; and
determining, based on second image information of the single-line laser beam on an object, obstacle position information

In a possible embodiment, controlling the emission assembly of the automatic cleaning device to emit the laser inclining in the ground-hitting direction, includes: controlling a receiving assembly of the automatic cleaning device to be turned on every time interval; and controlling the emission assembly to be turned on every two time intervals, where the receiving assembly is turned on synchronously when the emission assembly is turned on.

In a possible embodiment, the method further includes: acquiring first image information by means of an RGB image sensor of the automatic cleaning device; determining obstacle type information based on the first image information; and determining a travel path of an automatic cleaning device body based on the obstacle position information and the obstacle type information.

In a possible embodiment, the single-line laser beam is inclined at an angle ranging from 7.5° to 15° in the ground-hitting direction.

### BRIEF DESCRIPTION OF THE DRAWINGS

Various other advantages and benefits will become clear to those of ordinary skill in the art by reading the detailed description of the preferred embodiments below. The accompanying drawings are for the purpose of illustrating the preferred embodiments only, and are not considered to be a limitation on the present application. Moreover, the same reference sign is used to represent the same element throughout the drawings. In the accompanying drawings:

FIG. 1 is a schematic diagram of the use state of an automatic cleaning device according to an embodiment provided in the present application;

FIG. 2 is a schematic structural diagram of a sensing assembly of the automatic cleaning device according to an embodiment provided in the present application;

FIG. 3 is a schematic structural block diagram of the sensing assembly of the automatic cleaning device according to an embodiment provided in the present application;

FIG. 4 is a schematic diagram of the working principle of a wave lens assembly of the automatic cleaning device according to an embodiment provided in the present application;

FIG. 5 is a schematic diagram of the working principle of a filter assembly of the automatic cleaning device according to an embodiment provided in the present application;

FIG. 6 is a schematic structural diagram of a bracket of the sensing assembly of the automatic cleaning device according to an embodiment provided in the present application;

FIG. 7 is a schematic flowchart of the steps of a control method for the automatic cleaning device according to an embodiment provided in the present application;

FIG. 8 is a schematic diagram of an obstacle avoidance principle of the control method for the automatic cleaning device according to an embodiment provided in the present application;

FIG. 9 is a schematic diagram of laser emission control of the control method for the automatic cleaning device according to an embodiment provided in the present application;

FIG. 10 is a structural block diagram of a computer-readable storage medium according to an embodiment provided in the present application; and

FIG. 11 is a structural block diagram of an electronic device of an air conditioner according to an embodiment provided in the present application.

The correspondence between reference signs and element names are as follows:
110 Automatic cleaning device body, 120 Sensing assembly;
121 Emission assembly, 122 Receiving assembly, 123 RGB image sensor, 124 Fill-in light, 125 Protective lens, 126 Bracket, 127 Housing, 128 Pile-finding light receiver;
1211 Drive circuit, 1212 VCSEL unit, 1213 Focusing lens assembly, 1214 Wave lens assembly, 1221 Sensor, 1222 Lens assembly, 1223 Filter assembly, 1224 Signal processor, 1251 Hollow-out portion, 1261 Mounting hole.

### DETAILED DESCRIPTION

For better understanding of the above technical solutions, the technical solutions of the embodiments of the present application are explained in detail below through the accompanying drawings and specific embodiments. It should be understood that the embodiments of the present application and the specific features in the embodiment serve to explain in details the technical solutions of the embodiments of the present application, and are not intended to limit the technical solutions of the present application. The embodiments of the present application and the technical features in the embodiments are combined with each other without conflict.

In the related art, the robots are generally based on one scheme or a combination of multiple schemes from the following schemes: a binocular ranging-based obstacle avoidance scheme, a 3D ToF obstacle avoidance scheme, and a structured light obstacle avoidance scheme. However, the binocular ranging-based obstacle avoidance scheme and the 3D ToF obstacle avoidance scheme have low ranging accuracy, and the structured light obstacle avoidance scheme incurs high costs.

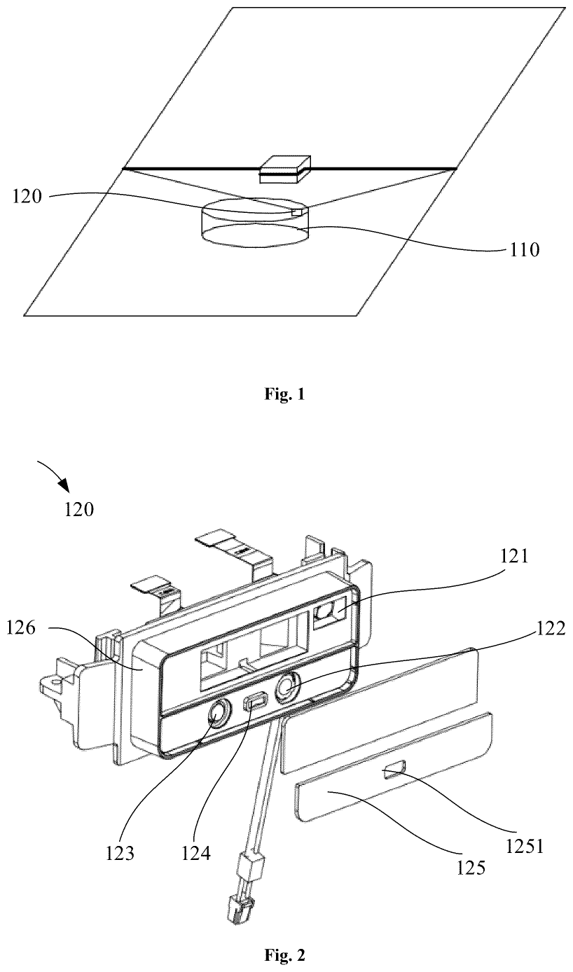

As shown in FIG. 1 to FIG. 6, according to the first aspect of the embodiment of the present application, an automatic cleaning device is provided. The automatic cleaning device includes an automatic cleaning device body 110 and a sensing assembly 120 disposed on the automatic cleaning device body 110. The sensing assembly 120 includes a line laser emitter and an RGB image sensor 123. The line laser emitter is used for emitting a line laser in an emission direction that is horizontally inclined downward.

The automatic cleaning device provided in the embodiment of the present application includes the automatic cleaning device body 110 and the sensing assembly 120. When in use, the automatic cleaning device body 110 is used for performing a service task, and the sensing assembly 120 is used for sensing surrounding environment information, specifically including obstacle information acquired by a line laser, an obstacle type recognized by RGB, or other information, for the automatic cleaning device body 110. When the automatic cleaning device provided in the embodiments of the present application is in use, a line laser is emitted by means of the line laser emitter, and because the output direction of the line laser emitter is horizontally inclined downward, the output direction of the line laser is inclined in the ground-hitting direction. When the laser is projected onto an obstacle, the contour of the laser projected undergoes deformation (as shown in FIG. 1, the black thick solid line indicates the laser), by which the position of the obstacle is determined. The line laser is projected to a region in front of the automatic cleaning device body 110, the projection distance of the laser is controlled by inclination in the ground-hitting direction, and with the movement of the automatic cleaning device body 110, the laser goes through the region in front of the automatic cleaning device body 110. In this way, the obstacle in the horizontal and vertical directions in front of the automatic cleaning device body 110 is recognized by one line laser, and the distance between the obstacle and the automatic cleaning device body 110 is determined, which facilitates obstacle avoidance of the automatic cleaning device body 110. In such a configuration, the obstacle avoidance accuracy is ensured while the cost of obstacle avoidance is reduced.

In the automatic cleaning device provided in the embodiment of the present application, the sensing assembly 120 further includes an RGB image sensor 123 (an RGB camera). When in use, the RGB image sensor 123 and a receiver is used in combination for joint obstacle avoidance. For example, an environmental picture is taken as first image information by means of the RGB image sensor 123, and the contour of an object in the first image information is recognized by analyzing the second image, such that the type of the obstacle is determined. In addition, the distance to the obstacle is determined by means of second image information acquired by the line laser emitter. In this way, the operation of the automatic cleaning device body 110 is jointly controlled by means of the distance to the obstacle and the type of the obstacle, which improves the operation quality of the automatic cleaning device body 110. Taking the automatic cleaning device body 110 as a cleaning device body and slippers and a weight scale, that are common in a home scene, as obstacles by way of example, the automatic cleaning device first takes an environmental picture by means of the RGB image sensor 123, and then recognizes, through contour matching, irregular obstacles such as slippers in front of the automatic cleaning device. Next, the obstacle avoidance strategy is executed in a collision-free mode by selecting a point at the irregular contour of the slippers closest to the cleaning device body in conjunction with the point cloud data of triangulation ranging by an emission assembly 121 and a receiving assembly 122. If the RGB image sensor 123 recognizes that the obstacle in front of the cleaning device body is a weight scale or other regular obstacles, the point cloud data of the triangulation ranging system of the emission assembly 121 and the receiving assembly 122 is invoked to select a close-fitting mode or a leakage-proof cleaning mode to execute the obstacle avoidance strategy. In this way, the obstacle-avoiding and operating effects of the automatic cleaning device body 110 are improved through the combined obstacle avoidance operation by the RGB image sensor 123, the emission assembly 121 and the receiving assembly 122.

In the traditional technology, some schemes involve binocular vision for navigation and obstacle avoidance. Similar to the basic principle of human eyes, the binocular vision works as follows: two parallel IR (infrared) cameras are used to take images; then, the distance to a specified point is calculated using a series of complex algorithms based on the difference (parallax) between two images; and in case of sufficient data, a depth map is further generated for calculating the position of an obstacle from a machine, thereby achieving intelligent obstacle avoidance. This scheme has high requirements for the relative position of two cameras for binocular obstacle avoidance, and pixel-level accuracy needs to be achieved for binocular position calibration, leading to great difficulty in manufacturing. Furthermore, according to the principle of binocular vision, the feature points of the pictures taken by the two cameras need to be identified and matched for triangulation ranging. However, matching will not be achieved for white walls or other obstacles without feature points, resulting in a ranging failure, and the requirement for accurate obstacle avoidance will not be met. In the automatic cleaning device provided in the embodiment of the present application, the emission assembly 121 of the sensing assembly 120 emits a laser in a ground-hitting direction, the position of an obstacle in front of the automatic cleaning device body 110 is further determined based on the projection state of the laser, and the obstacle avoidance requirement is met even only by emitting a line laser, thereby achieving low cost and high accuracy.

In the traditional technology, some schemes take advantage of a 3D ToF obstacle avoidance scheme for navigation and obstacle avoidance, of which the principle is as follows: a high-frequency light pulse is emitted to an object by using an infrared light source, the light pulse reflected back from the object is then received, and the distance from the detected object to a camera is calculated by detecting the flight (round-trip) time of the light pulse and the speed of light. The disadvantage of this scheme lies in that: a TOF sensor is expensive, and generally costs more than 100 yuan in order to meet the resolution requirement for obstacle avoidance of the automatic cleaning device body; moreover, limited by the timer TDC accuracy (nS-level), the short-range ranging accuracy is low, which is generally about 10 mm; meanwhile, it is likely to mismeasure the reflected light as the actual light in a reflective environment, resulting in inconsistent optical distance, and consequently inaccurately calculated time and large ranging error. In the automatic cleaning device provided in the embodiment of the present application, the emission assembly 121 of the sensing assembly 120 emits a laser in a ground-hitting direction, the position of an obstacle in front of the automatic cleaning device body 110 is further determined based on the projection state of the laser, and the obstacle avoidance requirement is met even only by emitting a line laser, thereby achieving low cost and high accuracy.

In the traditional technology, some schemes are active obstacle avoidance schemes based on structured light. In the ordinary binocular ranging, a light source is ambient light or white light or other light sources without encoding, and image recognition completely depends on the feature points of the photographed object itself, so matching has always been a challenge for binocular ranging. The structured light ranging, on the other hand, differs in that the projected light source is encoded, or characterized. Hence, the image generated by projecting the encoded light source onto an object and modulating the same by the depth of the surface of the object is taken. Because the structured light source is provided with a lot of feature points or is encoded, a lot of matching angular points or direct codewords are provided, such that the feature points are matched conveniently. In other words, the structured light actively provides a lot of feature points for matching or directly provides codewords, eliminating the need for the feature points on the photographed object itself, such that a better matching result is provided. The disadvantage of this scheme lies in that: the structured light is susceptible to sunlight, the power is limited under the premise of ensuring the safety of human eyes, and it is likely to flood speckles in case of strong ambient sunlight, resulting in a ranging failure; and the structured light is equivalently achieved by adding a speckle projector on the base of binocular ranging, leading to high cost. While in the present application, the emission assembly 121 of the sensing assembly 120 emits a laser in the ground-hitting direction, and the laser is thus less susceptible to sunlight or ambient light; and the position of an obstacle in front of the automatic cleaning device body 110 is further determined based on the projection state of the laser, and the obstacle avoidance requirement is met even only by emitting a line laser, thereby achieving low cost and high accuracy.

It is understood that, taking the automatic cleaning device body 110 of the automatic cleaning device moving on the horizontal plane as an example, the output direction of the emission assembly 121 being inclined in the ground-hitting direction means that the output direction of the emission assembly 121 is inclined towards the ground relative to the horizontal direction.

At present, some automatic cleaning device bodies involve a laser-based obstacle avoidance scheme, for example, a double-vertical-line laser is used in some automatic cleaning device bodies, in which case, if an obstacle exists on the lines of the double-line laser, the light is reflected to form an inflection point, and the distance to the obstacle is determined by comparing images for a difference, such that the obstacle is successfully avoided. However, there is a dead zone in the horizontal direction for two-vertical-line structured light, and if there is an obstacle, the automatic cleaning device body does not avoid the obstacle. Moreover, the double-line laser is costly. In the automatic cleaning device provided in the embodiment of the present application, the emission assembly 121 of the sensing assembly 120 emits a laser in a ground-hitting direction, the laser is projected in a ground-hitting way, the position of an obstacle in front of the automatic cleaning device body 110 is further determined based on the projection state of the laser, and the obstacle avoidance requirement is met even only by emitting a line laser, thereby achieving low cost and high accuracy.

Compared with the related art, the present disclosure includes at least the following beneficial effects.

The automatic cleaning device provided in the embodiments of the present application includes the automatic cleaning device body and the sensing assembly. When in use, the automatic cleaning device body is used for performing a service task and the sensing assembly is used for navigation for the automatic cleaning device body. When the automatic cleaning device provided in the embodiments of the present application is in use, a laser is emitted by means of the line laser emitter, and because the output direction of the line laser emitter is inclined in a ground-hitting direction, when the laser is projected onto an obstacle, the contour of the laser projected undergoes deformation, by which the position of the obstacle is determined. In addition, because the output direction of the line laser emitter is inclined in the ground-hitting direction, the laser is projected to a region in front of the automatic cleaning device body, the projection distance of the laser is controlled by inclination in the ground-hitting direction, and with the movement of the automatic cleaning device body, the laser goes through the region in front of the automatic cleaning device body. In this way, the obstacle in the horizontal and vertical directions in front of the automatic cleaning device body is recognized by one line laser, and the distance between the obstacle and the automatic cleaning device body is determined, which facilitates obstacle avoidance of the automatic cleaning device body. In such a configuration, the obstacle avoidance accuracy is ensured while the cost of obstacle avoidance is reduced. Moreover, the distance to the obstacle is acquired by means of the line laser emitter, and the contour of the obstacle is acquired by means of the RGB image sensor. In this way, the combined use of the RGB image sensor and the liner laser emitter allows more accurate determination of surrounding environment information by the automatic cleaning device body, which improves the obstacle-avoiding and operating effects of the automatic cleaning device body.

As shown in FIG. 2, in a possible embodiment, the output direction of the emission assembly 121 is inclined at an angle ranging from 7.5° to 15° in the ground-hitting direction.

In this technical solution, the angular range of the inclination direction of the emission assembly 121 is further provided, and the inclination angle of the output direction of the emission assembly 121 in the ground-hitting direction ranges from 7.5° to 15°. In such a configuration, the projection mode of the laser is further clarified, and the projection distance of the laser in front of the automatic cleaning device body 110 is controlled, such that the projection distance is controlled within a reasonable range, to ensure that the projection state of the laser is easily captured by the automatic cleaning device, while providing enough time for the automatic cleaning device body to avoid the obstacle. It is understood that, if the inclination angle of the output direction of the emission assembly 121 in the ground-hitting direction is less than 7.5°, the projection distance of the laser is excessively large to reduce the effective power of the laser and then lead to reduced obstacle avoidance accuracy, meanwhile, it is possible to project the laser into human eyes to bring discomfort to a user. If the inclination angle of the output direction of the emission assembly 121 in the ground-hitting direction is greater than 15°, the projection distance of the laser is excessively small to lead to reduced efficiency in determining the distance to the obstacle, or even make it impossible for the automatic cleaning device body 110 to avoid the obstacle due to insufficient time.

In a possible embodiment, the RGB image sensor 123 is used for acquiring environmental image information of the automatic cleaning device body 110. In this way, the environment image information is taken as first image information, the contour of an object in the first image information is recognized by analyzing the second image, such that the type of the obstacle is determined. In addition, the distance to the obstacle is determined by means of second image information acquired by the line laser emitter. In this way, the operation of the automatic cleaning device body 110 is jointly controlled by means of the distance to the obstacle and the type of the obstacle, which improves the operation quality of the automatic cleaning device body 110. Taking the automatic cleaning device body 110 as a cleaning device body and slippers and a weight scale, that are common in a home scene, as obstacles by way of example, the automatic cleaning device first takes an environmental picture by means of the RGB image sensor 123, and then recognizes, through contour matching, irregular obstacles such as slippers in front of the automatic cleaning device. Next, the obstacle avoidance strategy is executed in a collision-free mode by selecting a point at the irregular contour of the slippers closest to the cleaning device body in conjunction with the point cloud data of triangulation ranging by the emission assembly 121 and the receiving assembly 122. If the RGB image sensor 123 recognizes that the obstacle in front of the cleaning device body is a weight scale or other regular obstacles, the point cloud data of the triangulation ranging system of the emission assembly 121 and the receiving assembly 122 is invoked to select a close-fitting mode or a leakage-proof cleaning mode to execute the obstacle avoidance strategy. In this way, the obstacle-avoiding and operating effects of the automatic cleaning device body 110 are improved through the combined obstacle avoidance operation by the RGB image sensor 123, the emission assembly 121 and the receiving assembly 122.

In a possible embodiment, the automatic cleaning device further includes: a processor connected to the line laser emitter and the RGB image sensor 123. In such a configuration, it is convenient for the processor to acquire obstacle position information based on a line laser, and recognize the obstacle type based on the RGB image sensor 123, allowing the automatic cleaning device body to accurately acquire the surrounding environment and then work accurately. The processor is configured to execute the obstacle avoidance strategy based on information obtained from the line laser emitter and the RGB image sensor 123.

In a possible embodiment, the line laser emitter includes: an emission assembly 121 for emitting a single-line laser beam; and a receiving assembly 122 for acquiring second image information of the laser on an object.

In this technical solution, the emission assembly 121 is used for emitting a single-line laser beam. In such a configuration, it is possible to further reduce the cost of the sensing assembly 120, thereby reducing the cost of automatic cleaning device while ensuring the obstacle avoidance effect.

In this technical solution, a line laser is emitted by means of the emission assembly 121, the massive speckle projection scheme of structured light is simplified into single-line structured light, and the power is concentrated on one line laser under the power limit that ensures the human eye safety, such that the power density of the laser, the signal-to-noise ratio and the strong light resistance are improved.

In some examples, the emission assembly 121 is used for emitting a line laser that is projected in a ground-hitting manner, in such a configuration that the line laser bends when projected onto an obstacle, allowing determination of the position of the obstacle based on the state of bending.

In this technical solution, the sensing assembly 120 further includes a receiving assembly 122, by which the second image information of the laser on the object is received, and the second image information is then analyzed to determine the position of the obstacle and the distance to the obstacle, thereby facilitating navigation for the movement of the automatic cleaning device body 110.

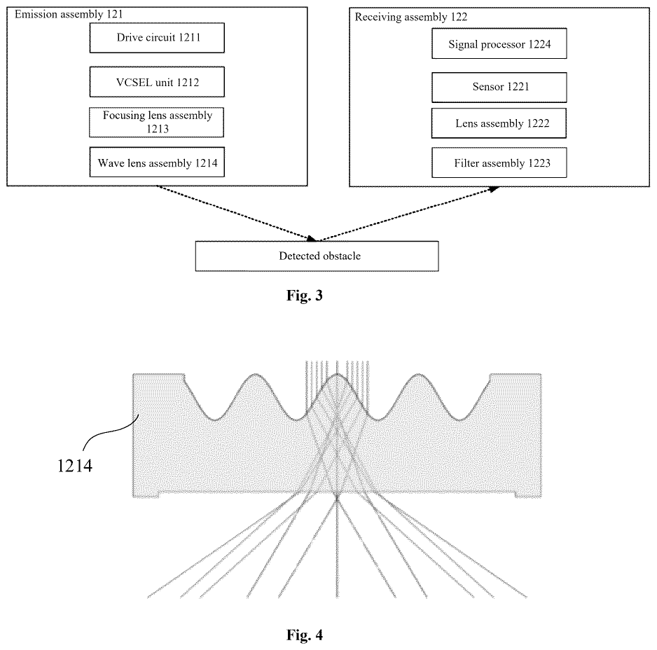

As shown in FIG. 3, in a possible embodiment, the emission assembly 121 includes a drive circuit 1211 and a VCSEL unit 1212. The drive circuit 1211 is connected to the VCSEL unit 1212, and the VCSEL unit 1212 is used for emitting a laser.

In this technical solution, the structural composition of the emission assembly 121 is further provided. The emission assembly 121 includes the drive circuit 1211 and the VCSEL unit 1212 (vertical cavity surface-emitting laser). The drive circuit 1211 is used for driving the VCSEL unit 1212 to emit a line laser. It is understood that the VCSEL unit 1212 is inclined in the ground-hitting direction, in such a configuration that the line laser emitted by the VCSEL unit 1212 is projected on a region in front of the automatic cleaning device body 110 to facilitate obstacle avoidance for the automatic cleaning device body 110.

It is understood that the drive circuit 1211 is used for supplying suitable drive voltage and current to the VCSEL unit 1212 to allow photoelectric conversion by the VCSEL unit 1212. The luminous intensity of the emission assembly 121 is in a linear relationship with the drive current, and accordingly, the response distance of the emission assembly 121 and the receiving assembly 122 is effectively controlled by controlling the drive current of the drive circuit 1211, in order to fulfill the function of remote obstacle detection for the automatic cleaning device.

In some examples, the wavelength of the VCSEL unit 1212 is 940 nm, 850 nm, 808 nm or other wavelength in infrared bands, and the key VCSEL indicators include luminous intensity at rated current, divergence angle (i.e., field of view, FOV), and external dimension. Here, the luminous intensity affects the sensing distance, and the divergence angle affects the line width of the line laser. The center of mass will not be accurately calculated if the line width is too small to occupy more than 1 pixel in the image. In case of detecting an obstacle with a dark color, the reflected energy tends to be low if the line width is too large which easily causes reduced energy density, making it impossible to perform effective detection. The common line width is 1-5 mm at a focusing position. The external dimensions mainly affect the structural design, in which the smaller the structure, the easier the miniaturization of the device, and will directly improves the emission distance and receiving distance, thereby improving the accuracy of triangulation ranging.

In some examples, the VCSEL unit 1212 has the wavelength of 850 nm and the FOV of 18°, and has VCSEL chips, with the size of 5 mm, arranged on a circular ceramic substrate, which ensures the accuracy of triangulation ranging.

In a possible embodiment, the emission assembly 121 further includes: a focusing lens assembly 1213 for focusing a laser emitted via the VCSEL unit 1212; and a wave lens assembly 1214 disposed on the side of the focusing lens assembly 1213 away from the VCSEL unit 1212.

In this technical solution, the structural composition of the emission assembly 121 is further provided. The emission assembly 121 includes the focusing lens assembly 1213 to further focus the circular spot of the VCSEL unit 1212. The line width of the line laser is flexibly controlled by setting the focal length of the focusing lens assembly 1213 and adjusting the object distance of the VCSEL unit 1212. The focusing lens assembly 1213 is spherical or aspherical. In this embodiment, due to small divergence angle of the VCSEL unit 1212, a spherical lens is used for cost performance.

In this technical solution, the emission assembly 121 further includes the wave lens assembly 1214, by which the focused laser is projected and which linearizes a point laser, such that the laser is projected in a linear shape.

As shown in FIG. 4, in some examples, the focused circular laser spot passes through the wave lens, and multiple light rays passing through crests and troughs are emitted vertically to a line center. The light ray subjected to the crest-to-trough depth of 0.5 has the largest emergence angle to reach a line edge. For the light rays subjected to the crests (troughs) and the crest-to-trough depth of 0.5, multiple waves of light are superimposed and emitted to the line center and edge depending on position, thereby forming the line. The emission of a single-line laser beam is achieved as long as the wave surface shape with the perpendicularity of 90° is designed on the wave lens at the same time. In order to improve the detection angle for obstacle avoidance, the emission assembly 121 provided in the embodiment of the present application has the laser divergence angle of 130°.

In a possible embodiment, the receiving assembly 122 includes: a sensor 1221; a lens assembly 1222 for imaging, on the sensor 1221, the line laser reflected by an object; a filter assembly 1223 disposed on the side of the lens assembly 1222 away from the sensor 1221; and a signal processor 1224 connected to the sensor 1221 and used for converting a photoelectric signal into a digital signal.

In this technical solution, the structural composition of the receiving assembly 122 is further provided. The receiving assembly 122 includes the lens assembly 1222, the sensor 1221 and the filter assembly 1223. When the second image information is acquired by means of the receiving assembly 122, light rays first pass through the filter assembly 1223, which only allows the light of the corresponding wavelength to pass through, but cut off the light of other wavelengths, thereby preventing serious stray light in the image caused by receiving ambient light, which improves the signal-to-noise ratio of the system.

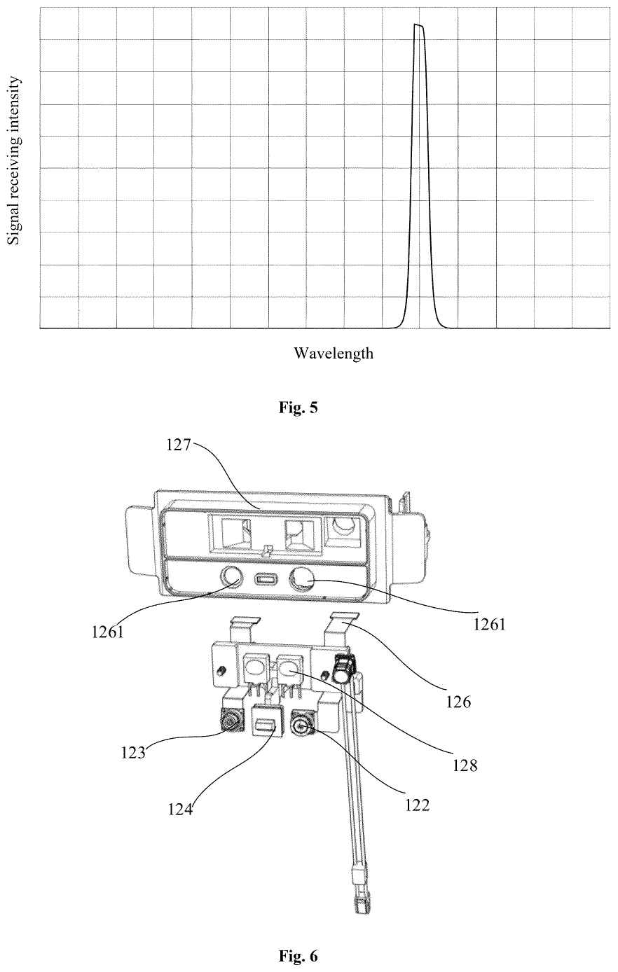

In some examples, as shown in FIG. 5, the abscissa indicates the wavelength, the ordinate indicates the signal receiving intensity, and the filter assembly 1223 is a narrow-band filter, such as a narrow-band filter with a wavelength of 850 nm±10 nm. In this way, only the light of the corresponding wavelength is allowed to pass through, and the light of other wavelengths is cut off, thereby preventing serious stray light in the image caused by receiving ambient light. The narrowband filter improves the signal-to-noise ratio of the system.

In this technical solution, the lens assembly 1222 is disposed to image, on the sensor 1221, the line laser reflected by the obstacle. The key indicators of the lens assembly 1222 include field of view, f-number (F#), focal length, distortion or the like. In this embodiment, a lens with a large field of view of 120° is used to allow for obstacle detection in a larger range; the focal length is 1.6 mm, where the larger the focal length, the higher the ranging accuracy according to the triangulation ranging formula; F# is 2.2, where with constant focal length, the smaller the F#, the larger the lens aperture, and the larger the amount of input light; and the distortion is 2.5%, where the smaller the distortion, the better, and the excessive distortion is likely to affect the edge ranging accuracy. In case of excessive original distortion, the distortion is also calibrated by means of internal reference calibration, but at the expense of the effective FOV.

In this technical solution, the sensor 1221 is a sensor which is a sensing chip, with the main indicators including resolution, exposure mode, pixel size, photosensitive efficiency and the like. According to the triangulation ranging formula, the higher the resolution, the higher the ranging accuracy, but with increasing cost. The exposure mode is categorized into rolling exposure and global exposure which is more suitable for fast-moving scenes. The sensing assembly 120 in the present application needs to be applied to the movable automatic cleaning device body 110 and strictly matched with the line laser in timing, and thus the sensor with the VGA resolution and the rolling exposure mode is used in this embodiment. The larger the pixel size, the better the photosensitive property, and thus the pixel size of 3.75 μm is used in this embodiment. The higher the photosensitive efficiency, the higher the photoelectric conversion efficiency with the same emission power, the brighter the line laser presented in the image, and the more conducive to the implementation of dark materials and long-distance ranging, and thus, the sensor with the photosensitive efficiency of 40% is used in this embodiment.

In this technical solution, the signal processor 1224 is used for converting the photocurrent signal of the infrared receiving unit into a digital signal, which is then sent to the processor of the automatic cleaning device for decoding so as to present a completed image, and the position of the center of mass is calculated, thereby completing the calculation of triangulation ranging.

It is understood that the sensor 1221, the lens assembly 1222 and the filter assembly 1223 are combined to form an IR (infrared) camera.

As shown in FIG. 6, in a possible embodiment, the sensing assembly 120 further includes: a housing 127 connected to the automatic cleaning device body 110; a bracket 126 for connection to the housing 127. The line laser emitter and/or the RGB image sensor 123 are connected to the bracket 126.

In this technical solution, the structural composition of the sensing assembly is further provided. The sensing assembly includes the housing 127 and the bracket 126. The bracket 126 provides installation positions for the line laser emitter and/or the RGB image sensor 123. During assembling, the line laser emitter and/or the RGB image sensor 123 is first assembled on the bracket 126, which is then connected to the housing 127, and finally, the housing 127 is connected to the automatic cleaning device body 110. In this way, the modular assembling of the sensing assembly is achieved, which is convenient for the precise positioning of the line laser emitter and/or the RGB image sensor 123.

In a possible embodiment, the sensing assembly 120 further includes: a fill-in light 124 connected to the bracket 126 and used for filling light for the RGB image sensor 123.

In this technical solution, the sensing assembly further includes the fill-in light 124, by which the light is filled for the RGB image sensor 123, such that the RGB image sensor 123 acquires the environment image information with more appropriate brightness, making it possible to more accurately determine the type of obstacle.

In a possible embodiment, the automatic cleaning device further includes: a protective lens 125 for covering at least one of: the RGB image sensor 123, the fill-in light 124, or the line laser emitter.

In this technical solution, the automatic cleaning device further includes the protective lens 125, which covers at least one of the RGB image sensor 123, the fill-in light 124, and the line laser emitter to achieve dustproof and waterproof effects, such that the service life of the sensing assembly is prolonged while the sensing accuracy is increased.

In some examples, the protective lens 125 is prepared from a single lens or by stacking a plurality of lenses.

In a possible embodiment, a hollow-out portion 1251 is formed in a region of the protective lens 125 corresponding to the fill-in light 124, in such a configuration that the light transmittance of the fill-in light 214 is improved to guarantee the intensity of filled light.

In a possible embodiment, a mounting hole 1261 is formed in the housing 127, and the line laser emitter and/or the RGB image sensor 123 send or receive a signal via the mounting hole 1261.

By forming the mounting hole 1261 in the housing 127, the aperture of the mounting hole 1261 is slightly larger than the line laser emitter and/or the RGB image sensor 123, so as to facilitate the signal emitting and receiving by the line laser emitter and/or the RGB image sensor 123 and the accurate acquisition of the position and contour of the obstacle, allowing more accurate operation of the automatic cleaning device body 110.

In a possible embodiment, the sensing assembly 120 further includes:
a pile-finding light receiver 128 for receiving a pile-finding signal emitted by a base station.

In this technical solution, the sensing assembly further includes the pile-finding light receiver 128, which is provided to facilitate receiving of a pile-finding signal emitted by the base station, so as to enable the automatic cleaning device body 110 to return to the base station according to the received signal, facilitating the smooth conduction of operations such as charging, dust collection, cleaning.

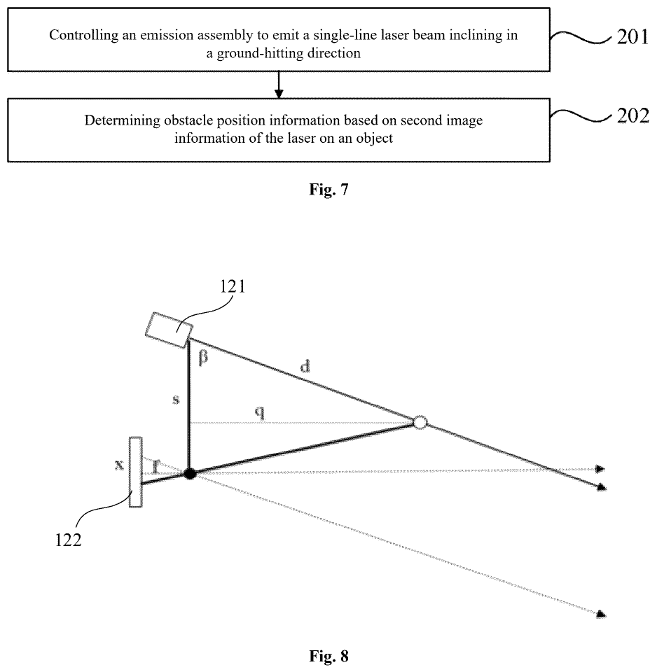

As shown in FIG. 7, according to the second aspect of the embodiment of the present application, a control method is provided for controlling the automatic cleaning device in any one of the technical solutions as described above. The control method includes:

In step 201, an emission assembly is controlled to emit a single-line laser beam inclining in a ground-hitting direction. Understandably, due to the inclination configuration of the emission assembly, a laser inclined in the ground-hitting direction is emitted just by turning on the emission assembly.

In step 202, obstacle position information is determined based on second image information of the laser on an object. It is understood that, when the laser in the ground-hitting direction is projected onto an obstacle, the laser bends, and the position of the obstacle is determined by means of the state of bending.

The control method provided in the embodiment of the present application is used for controlling the automatic cleaning device in any one of the technical solutions as described above, and thus has all the beneficial effects of the cleaning device in the above technical solutions.

In the control method provided in the embodiments of the present application, a laser is emitted by means of the emission assembly 121, and because the output direction of the emission assembly 121 is inclined in the ground-hitting direction, when the laser is projected onto an obstacle, the contour of the laser projected undergoes deformation, by which the position of the obstacle is determined. In addition, because the output direction of the emission assembly 121 is inclined in the ground-hitting direction, the laser is projected to a region in front of the automatic cleaning device body 110, and the projection distance of the laser is controlled by inclination in the ground-hitting direction, and with the movement of the automatic cleaning device body 110, the laser goes through the region in front of the automatic cleaning device body 110. In this way, the obstacle in the horizontal and vertical directions in front of the automatic cleaning device body 110 is recognized by one line laser, and the distance between the obstacle and the automatic cleaning device body 110 is determined, which facilitates obstacle avoidance of the cleaning device body. In such a configuration, the obstacle avoidance accuracy is ensured while the cost of obstacle avoidance is reduced.

In a possible embodiment, the step of controlling the emission assembly to emit the laser inclining in the ground-hitting direction includes: controlling the receiving assembly to be turned on every time interval; and controlling the emission assembly to be turned on every two time intervals, where the receiving assembly is turned on synchronously when the emission assembly is turned on.

In this technical solution, the control mode of laser emission is further provided. The receiving assembly 122 is turned on once every time interval, that is to say, the receiving assembly 122 acquires the second image information once every time interval. The emission assembly 121 is turned on once every two time intervals, that is to say, the laser is emitted by the emission assembly 121 once every two time intervals. In this way, taking four time intervals as an example, the receiving assembly 122 is turned on four times, and the emission assembly 121 is turned on twice. In this way, four pieces of second image information is acquired, wherein two pieces of second image information include the projection results of laser. In this way, the four pieces of second image information are compared to eliminate the influence from ambient light to thus accurately recognize the projection state of the laser, such that the position information of the obstacle is determined. The movement trend between the automatic cleaning device body 110 and the obstacle is determined simultaneously.

In the automatic cleaning device provided in the embodiment of the present application, the output direction of the emission assembly 121 is inclined at an angle ranging from 7.5° to 15° in the ground-hitting direction, and obstacles in the vertical and horizontal directions are detected simultaneously. Moreover, by setting the time interval and controlling the receiving assembly 122 to be turned on at intervals, the high-cost global exposure scheme is replaced by a rolling shutter scheme, such that the cost performance is guaranteed. Rolling shutter is characterized by the gradual exposure of CMOS pixels (diodes). That is, the CMOS pixels are exposed one after another, which has the advantage of achieving a higher frame rate, but with the disadvantage of phenomena such as Jello effects caused by partial exposure (partial exposure), skewing (skew) and wobbling (wobble) when the receiving assembly 122 moves quickly. However, the moving speed of the automatic cleaning device is generally below 30 cm/s, which is much lower than the exposure speed at the ms-level or even the us-level of the selected rolling shutter, avoiding the Jello effect. The global shutter is characterized by the fact that the entire scene is exposed at the same time. All pixel points (diodes) of the sensor 1221 acquire light rays at the same time and are exposed at the same time. Unlike rolling shutter, such a simultaneous exposure does not undergo the Jello effect. However, for chips with the same resolution, the cost of the rolling shutter is only 50% of that of the global shutter, such that the cost performance of the obstacle avoidance system of the automatic cleaning device is greatly improved.

As shown in FIG. 9, the receiving assembly 122 initiates the exposure for 2.5 ms and simultaneously sends a synchronization signal to the emission assembly 121, and after an interval of 33 ms, the receiving assembly 122 initiates the second exposure for 2.5 ms. The horizontal line laser of the emission assembly 121 is emitted at intervals according to the synchronization signal, and the emission time of the emission assembly 121 is strictly matched with the exposure time of the receiving assembly 122, such that the effective brightness of the line laser in the image is ensured, and the overall emission time of the line laser is reduced, thereby meeting the standard of laser safety to human eyes.

In a possible embodiment, the step of determining the obstacle position information based on the second image information of the laser on the object includes:
determining a distance between the obstacle and the sensing assembly 120 by the following formula:

$$q = fs / x .$$

Here, q indicates the distance between the obstacle and the automatic cleaning device body 110, f indicates the focal length of the receiving assembly 122, s indicates the distance between the center of the emission assembly 121 and the center of the receiving assembly 122, and x indicates the distance from the pixel point of the sensor 1221 of the sensing assembly 120 to the center of the sensor 1221.

In this technical solution, a method for determining the distance to an obstacle is further provided, and as shown in FIG. 1 and FIG. 2, the emission assembly 121 and the receiving assembly 122 are included in this technical solution. The emission assembly 121 is used for emitting one or more lasers (which is line lasers or lasers of other shape, and this embodiment takes a single-horizontal-line laser as an example). The receiving assembly 122 is a CCD or CMOSIR (infrared) camera, and the distance between the automatic cleaning device body and the obstacle is detected by means of triangulation ranging. The principle of triangulation ranging is shown in FIG. 8, where the measured distance is q=fs/x according to the similar triangles, with q indicating the distance between the emitting and receiving center and the obstacle, f indicating the focal length of the receiving assembly 122, s indicating the distance between the center of the emission assembly 121 and the center of the receiving assembly 122, and x indicating the distance from the center of the imaging chip sensor to the pixel point on the imaging chip sensor of the receiving assembly 122 to which the laser emitted by the emission assembly 121 is reflected from the surface of an obstacle. The distance between the obstacle and the sensing assembly 120 is determined based on the focal length of the receiving assembly 122, the distance between the emission assembly 121 and the receiving assembly 122 and the detecting results of the sensor 1221, such that the position of the obstacle is accurately determined to facilitate obstacle avoidance for a device or means provided with the sensing assembly.

In a possible embodiment, the control method further includes: acquiring first image information by means of an RGB image sensor; determining obstacle type information based on the first image information; and determining a travel path of the automatic cleaning device body based on the obstacle position information and obstacle type information.

In this technical solution, the control method further includes acquiring the type of obstacle by the RGB image sensor 12, where the RGB image sensor 123 is used in combination with the receiver for joint obstacle avoidance. For example, an environment picture is taken as the first image information by the RGB image sensor 123, and the contour of an object in the first image information is recognized by analyzing the second image, such that the type of obstacle is determined. The distance to the obstacle is determined by means of second image information acquired by the receiver. In this way, the operation of the automatic cleaning device body 110 is jointly controlled by means of the distance to the obstacle and the type of the obstacle, which improves the operation quality of the automatic cleaning device body 110. Taking the automatic cleaning device body 110 as a cleaning device body and slippers and a weight scale, that are common in a home scene, as obstacles by way of example, the automatic cleaning device first takes an environmental picture by means of the RGB image sensor 123, and then recognizes, through contour matching, irregular obstacles such as slippers in front of the automatic cleaning device. Next, the obstacle avoidance strategy is executed in a collision-free mode by selecting a point at the irregular contour of the slippers closest to the cleaning device body in conjunction with the point cloud data of triangulation ranging by the emission assembly 121 and the receiving assembly 122. If the RGB image sensor 123 recognizes that the obstacle in front of the cleaning device body is a weight scale or other regular obstacles, the point cloud data of the triangulation ranging system of the emission assembly 121 and the receiving assembly 122 is invoked to select a close-fitting mode or a leakage-proof cleaning mode to execute the obstacle avoidance strategy. In this way, the obstacle-avoiding and operating effects of the automatic cleaning device body 110 are improved through the combined obstacle avoidance operation by the RGB image sensor 123, the emission assembly 121 and the receiving assembly 122.

In a possible embodiment, the step of determining the travel path of the automatic cleaning device body includes: controlling the automatic cleaning device body to maintain in the current travel direction when no obstacle exists in front of the automatic cleaning device body; and changing the travel path of the automatic cleaning device body when the obstacle position information indicates an obstacle in the horizontal direction, causing the automatic cleaning device body to bypass the obstacle.

In this technical solution, a specific step of determining the travel path of the automatic cleaning device body 110 is further provided, in which when no obstacle exists in front of the automatic cleaning device body 110, the automatic cleaning device body 110 is controlled to maintain in the current travel direction, so as to control the automatic cleaning device body 110 to perform an operation task as soon as possible; and when the obstacle position information indicates an obstacle in the horizontal direction, the travel path of the automatic cleaning device body is changed to cause the automatic cleaning device body 110 to bypass the obstacle, making it possible to avoid collisions between the automatic cleaning device body 110 and the obstacle.

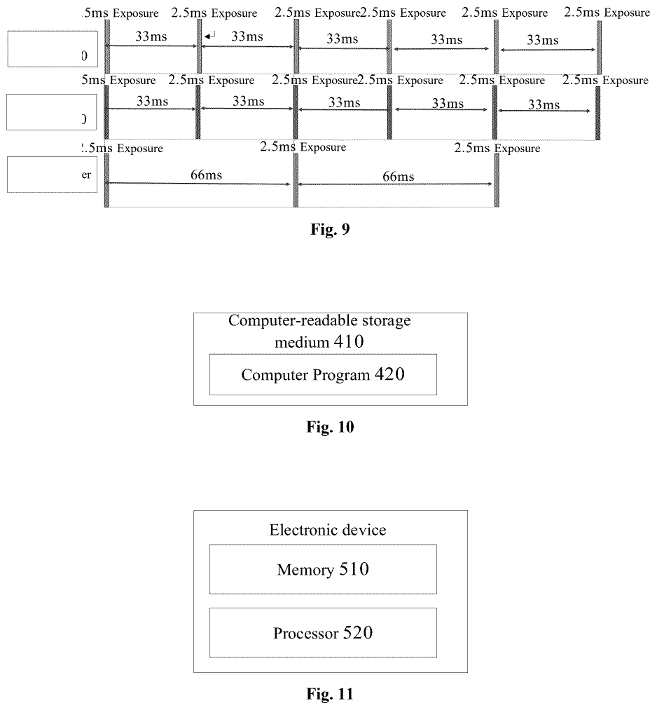

As shown in FIG. 10, according to a third aspect of the embodiment of the present application, a computer-readable storage medium 410 is provided. The computer-readable storage medium 410 stores a computer program 420 to implement the control method in any one of the above technical solutions as described above.

Because the computer-readable storage medium 410 provided in the embodiment of the present application implements the control method in any one of the technical solutions as described above, the computer-readable storage medium 410 has all the beneficial effects of the control methods in the technical solutions as described above.

By the computer-readable storage medium 410 provided in the embodiments of the present application, a laser is emitted by means of the emission assembly 121, and because the output direction of the emission assembly 121 is inclined in the ground-hitting direction, when the laser is projected onto an obstacle, the contour of the laser projected undergoes deformation, by which the position of the obstacle is determined. In addition, because the output direction of the emission assembly 121 is inclined in the ground-hitting direction, the laser is projected to a region in front of the automatic cleaning device body 110, and the projection distance of the laser is controlled by inclination in the ground-hitting direction, and with the movement of the automatic cleaning device body 110, the laser goes through the region in front of the automatic cleaning device body 110. In this way, the obstacle in the horizontal and vertical directions in front of the automatic cleaning device body 110 is recognized by one line laser, and the distance between the obstacle and the automatic cleaning device body 110 is determined, which facilitates obstacle avoidance of the cleaning device body. In such a configuration, the obstacle avoidance accuracy is ensured while the cost of obstacle avoidance is reduced.

Based on such an understanding, the technical solutions of the present application are embodied in the form of a software product, which is stored in a non-volatile storage medium (which is a CD-ROM, a USB flash disk, a portable hard disk, or the like), and include a number of instructions to cause a computer device (which is a personal computer, a server, or a network device, or the like) to perform the method described in each implementation scene of the present application.

As shown in FIG. 11, according to a fourth aspect of the embodiment of the present application, an electronic device is provided. The electronic device includes: a memory 510 storing a computer program 420; and a processor 520 capable of executing the computer program 420, where the processor 520, when executing the computer program 420, implements the control method in any one of the technical solutions as described above.

Because the electronic device provided in the embodiment of the present application implements the control method in any one of the technical solutions as described above, the electronic device has all the beneficial effects of the control methods in the technical solutions as described above.

According to the electronic device provided in the embodiments of the present application, a laser is emitted by means of the emission assembly 121, and because the output direction of the emission assembly 121 is inclined in the ground-hitting direction, when the laser is projected onto an obstacle, the contour of the laser projected undergoes deformation, by which the position of the obstacle is determined. In addition, because the output direction of the emission assembly 121 is inclined in the ground-hitting direction, the laser is projected to a region in front of the automatic cleaning device body 110, and the projection distance of the laser is controlled by inclination in the ground-hitting direction, and with the movement of the automatic cleaning device body 110, the laser goes through the region in front of the automatic cleaning device body 110. In this way, the obstacle in the horizontal and vertical directions in front of the automatic cleaning device body 110 is recognized by one line laser, and the distance between the obstacle and the automatic cleaning device body 110 is determined, which facilitates obstacle avoidance of the cleaning device body. In such a configuration, the obstacle avoidance accuracy is ensured while the cost of obstacle avoidance is reduced.

According to a further aspect of the embodiment of the present application, a cleaning system is provided. The cleaning system includes: the automatic cleaning device in any one of the technical solutions as described above; and a cleaning base station for providing maintenance to the automatic cleaning device.

Because the cleaning system provided in the embodiment of the present application includes the automatic cleaning device in any one of the technical solutions as described above, the cleaning system has all the beneficial effects of the automatic cleaning device in the any one of the technical solutions as described above, the details of which will not be repeated here.

When the cleaning system provided in the embodiment of the present application executes a cleaning operation, the automatic cleaning device is far away from the cleaning base station to execute the cleaning task, and when the automatic cleaning device completes cleaning or needs to be maintained, the automatic cleaning device returns to the cleaning base station, which performs charging, mop washing, dust collection or water replenishing for the automatic cleaning device.

In some examples, the electronic device further includes a user interface, a network interface, a camera, a radio-frequency (Radio Frequency, RF) circuit, a sensor 1221, an audio circuit, a WI-FI module and the like. The user interface includes a display (Display), an input unit such as a keyboard (Keyboard), or the like, and in some embodiments, further includes a USB interface, a card reader interface and the like. In some embodiments, the network interface includes a standard wired interface, a standard wireless interface (such as a WI-FI interface) and the like.

In an exemplary embodiment, the electronic device further includes an input-output interface and a display device, with respective functional units capable of communicating with each other via a bus. The memory 510 stores a computer program 420, and the processor 520 is used for executing the program stored on the memory 510 to execute the method in the above embodiments.

The storage medium further includes an operating system and a network communication module. The operating system is the program that manages the hardware and software resources of the physical device described above, and supports the running of information processing programs and other software and/or programs. The network communication module is used for implementing the communication between various components inside the storage medium, as well as the communication between other hardware and software in the physical information processing device.

Based on the description of the embodiments above, those skilled in the art clearly understand that the present application is implemented by virtue of software plus a necessary general-purpose hardware platform, or by hardware.

The present application is described with reference to the flowchart and/or block diagram of the method, device (system), and computer program 420 product according to the embodiments of the present application. It should be understood that individual processes and/or blocks, and their combinations, in the flowchart and/or block diagram are implemented by the instructions of the computer program 420. These instructions of the computer program 420 is provided to a general-purpose computer, a special-purpose computer, an embedded computer, or a processor 520 of an additional programmable data processing device to produce a machine, such that a device for implementing the function(s) specified in one or more processes in the flowchart and/or in one or more blocks in the block diagram is produced by means of the instructions executed by the computer or the processor 520 of the additional programmable data processing device.

In the present disclosure, the terms “first”, “second” and “third” and “fourth” are for descriptive purposes only, and should not be construed as indicating or implying relative importance. The term “a plurality of” indicates two or more, unless otherwise clearly defined. The terms such as “installation”, “coupling”, “connection”, and “fixation” should be understood in a broad sense. For example, “connection” is a fixed connection, or a detachable connection, or an integrated connection; and “coupling” is coupling directly, or indirectly via an intermediate medium. For those of ordinary skill in the art, the specific meanings of the above terms in the present disclosure are understood according to specific conditions.

In the description of the present disclosure, it should be understood that the terms such as “up”, “down”, “left”, “right”, “front” and “back” indicate orientational or positional relations based on the orientational or position relations shown in the accompanying drawings only for the purposes of describing the present disclosure and simplifying the description, instead of indicating or implying that a mentioned apparatus or element must have a specific direction or must be constructed and operated in a specific orientation. Therefore, these terms should not be understood as a limitation to the present disclosure.

In the description of this Specification, the descriptions of terms such as “one embodiment”, “some embodiments”, “specific embodiments”, “specific examples” or “some examples” or the like mean that the specific features, structures, materials or characteristics described in conjunction with the embodiment or example are included in at least one embodiment or example of the present disclosure. In this specification, the schematic expressions of the above terms do not necessarily refer to the same embodiment or example. Moreover, the described specific features, structures, materials, or characteristics can be combined in an appropriate manner in any one or more embodiments or examples.

Described above are merely preferred embodiments of the present disclosure, and are not intended to limit the present disclosure. Various modifications and variations can be made to the present disclosure for those skilled in the art. Any modification, equivalent substitution, improvement and the like made within the spirit and principle of the present disclosure shall be construed as being included within the protection scope of the present disclosure.

What is claimed is:

1. An automatic cleaning device, comprising:
an automatic cleaning device body; and
a sensing assembly, wherein the sensing assembly is disposed on the automatic cleaning device body, and comprises a line laser emitter and an RGB image sensor, the line laser emitter being configured for emitting a line laser, and an emission direction of the line laser being horizontally and downward inclined; and
wherein the line laser emitter comprises an emission assembly configured for emitting a single-line laser beam.

2. The automatic cleaning device according to claim 1, wherein
the RGB image sensor is configured for acquiring environmental image information of the automatic cleaning device body as first image information.

3. The automatic cleaning device according to claim 1, further comprising:
a processor, wherein the processor is connected to the line laser emitter and the RGB image sensor, and configured for executing an obstacle avoidance strategy based on information obtained from the line laser emitter and the RGB image sensor.

4. The automatic cleaning device according to claim 1, wherein the line laser emitter further comprises:
a receiving assembly configured for acquiring second image information of the laser on an object.

5. The automatic cleaning device according to claim 4, wherein the emission assembly comprises:
a drive circuit; and
a vertical cavity surface-emitting laser (VCSEL) unit, wherein the drive circuit is connected to the VCSEL unit, the VCSEL unit is configured for emitting the laser, and the drive circuit is configured for driving the VCSEL unit to emit the laser.

6. The automatic cleaning device according to claim 5, wherein the emission assembly further comprises:
a focusing lens assembly configured for focusing the laser emitted via the VCSEL unit; and
a wave lens assembly disposed on a side of the focusing lens assembly away from the VCSEL unit;
wherein the wave lens assembly is configured for projecting a focused laser in a linear shape.

7. The automatic cleaning device according to claim 4, wherein the receiving assembly comprises:
a sensor;
a lens assembly configured for imaging the line laser reflected by the object on the sensor;
a filter assembly disposed on a side of the lens assembly away from the sensor; and
a signal processor connected to the sensor, and configured for converting a photoelectric signal into a digital signal.

8. The automatic cleaning device according to claim 1, wherein the sensing assembly further comprises:
a housing connected to the automatic cleaning device body; and
a bracket configured for connection to the housing,
wherein at least one of the line laser emitter or the RGB image sensor is connected to the bracket.

9. The automatic cleaning device according to claim 8, wherein the sensing assembly further comprises:
a fill-in light connected to the bracket and configured for filling light for the RGB image sensor.

10. The automatic cleaning device according to claim 9, further comprising:
a protective lens configured for covering at least one of the RGB image sensor, the fill-in light, or the line laser emitter.

11. The automatic cleaning device according to claim 10, wherein
a hollow-out portion is formed in a region of the protective lens corresponding to the fill-in light.

12. The automatic cleaning device according to claim 8, wherein
a mounting hole is formed in the housing, and at least one of the line laser emitter or the RGB image sensor either sends or receives a signal via the mounting hole.

13. The automatic cleaning device according to claim 8, wherein the sensing assembly further comprises:
a pile-finding light receiver configured for receiving a pile-finding signal emitted by a base station.

14. The automatic cleaning device according to claim 13, wherein
the pile-finding light receiver is disposed on the bracket.

15. The automatic cleaning device according to claim 1, wherein an output direction of the emission assembly is inclined at an angle ranging from 7.5° to 15° in a ground-hitting direction.

16. A cleaning system, comprising:
an automatic cleaning device, wherein the automatic cleaning device comprises:
an automatic cleaning device body; and
a sensing assembly, wherein the sensing assembly is disposed on the automatic cleaning device body, and comprises a line laser emitter and an RGB image sensor, the line laser emitter being configured for emitting a line laser, and an emission direction of the line laser being horizontally and downward inclined; and
wherein the line laser emitter comprises an emission assembly configured for emitting a single-line laser beam; and
a cleaning base station configured for providing maintenance to the automatic cleaning device.

17. A method for controlling an automatic cleaning device, comprising:
controlling an emission assembly of the automatic cleaning device to emit a single-line laser beam inclining in a ground-hitting direction; and
determining, based on second image information of the single-line laser beam on an object, obstacle position information.

18. The method according to claim 17, wherein controlling the emission assembly of the automatic cleaning device to emit the single-line laser beam inclining in the ground-hitting direction, comprises:
controlling a receiving assembly of the automatic cleaning device to be turned on every time interval; and
controlling the emission assembly to be turned on every two time intervals, where the receiving assembly is turned on synchronously when the emission assembly is turned on.

19. The method according to claim 17, further comprising:
acquiring first image information by means of an RGB image sensor of the automatic cleaning device;
determining obstacle type information based on the first image information; and
determining a travel path of an automatic cleaning device body based on the obstacle position information and the obstacle type information.

20. The method according to claim 17, wherein the single-line laser beam is inclined at an angle ranging from 7.5° to 15° in the ground-hitting direction.
